(19) United States
(12) Patent Application Publication
(10) Pub. No.: US 2005/0233277 A1
(43) Pub. Date: Oct. 20, 2005

(54) Dental injection device

(76) Inventor: Jay Marlin, Boston, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/087,387

(22) Filed: Mar. 23, 2005

Related U.S. Application Data
(60) Provisional application No. 60/562,508, filed on Apr. 15, 2004.

(51) Int. Cl. A61C 3/08

(52) U.S. Cl. 433/25

(57) ABSTRACT

A hand held dental injection device including a conduit having an inlet and an outlet. A rotatable conveying screw having conveyance flutes is positioned within the conduit for conveying thermoplastic material received from the inlet of the conduit alongside the screw through the conduit and out the outlet with the conveyance flutes. A heating system heats the thermoplastic material. A needle is mounted to the outlet of the conduit for directing the thermoplastic material into dental cavities.

### RELATED APPLICATION

This application claims the benefit of U.S. Provisional Application No. 60/562,508, filed Apr. 15, 2004. The entire teachings of the above application are incorporated herein by reference.

### BACKGROUND

Dental injection guns are commonly used for injecting molten thermoplastic material into dental cavities through a needle. Typically, a plunger mechanism is employed for forcing the molten thermoplastic material through the needle. In such a gun, usually two small sticks of thermoplastic material are loaded end to end within the gun prior to use. However, when more than two sticks of thermoplastic material are needed for use on a patient, the gun has to be refilled, interrupting the procedure.

### SUMMARY

The present invention provides a device for delivering molten polymer or thermoplastic material which can go for longer periods of time before requiring refilling. In some embodiments, the present invention provides a hand held dental injection device including a conduit having an inlet and an outlet. A rotatable conveying screw having conveyance flutes can be positioned within the conduit for conveying thermoplastic material received from the inlet of the conduit alongside the screw, through the conduit, and out the outlet with the conveyance flutes. A heating system can heat the thermoplastic material. A needle can be mounted to the outlet of the conduit for directing the thermoplastic material into dental cavities.

In particular embodiments, a motor drive can rotate the conveying screw. An actuator can actuate the motor drive and can vary the speed of the motor drive to vary the speed that the thermoplastic material exits the outlet. A feed assembly can feed the thermoplastic material into the inlet of the conduit. The conduit can be mounted to a hand held body. The hand held body can include a handle extending generally laterally from the body in which the feed assembly can be positioned. The feed assembly can be spring loaded and can feed sticks of thermoplastic material into the inlet of the conduit. The sticks can be fed at a right angle to the conveyor screw. The feed assembly can be a removable clip whereby the clip can be filled with sticks of the thermoplastic material. A controller can control the motor drive and the heating system. The controller can allow rotation of the conveying screw only when the thermoplastic material has been sufficiently heated. Heat shielding material can surround at least a portion of the heating system. The heat shielding material can extend to the needle, for example, around the bottom of the needle.

The present invention also provides a method of filling dental cavities with a hand held dental injection device including rotating a conveying screw having conveyance flutes within a conduit. The conduit has an inlet and an outlet. The conveying screw can convey thermoplastic material received from the inlet of the conduit alongside the screw, through the conduit, and out the outlet with the conveyance flutes. The thermoplastic material can be heated with a heating system. The thermoplastic material can be directed into the dental cavities with the needle mounted to the outlet of the conduit.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side sectional view of an embodiment of a device for delivering molten thermoplastic in accordance with the present invention.

FIG. 2 is an exploded view of components for the embodiment of FIG. 1.

FIG. 3 is a perspective view of a conveying screw.

FIG. 4 is a perspective view of a feed barrel conduit and nozzle.

FIG. 5 is a perspective view of a needle assembly.

FIG. 6 is a exploded view of the needle assembly of FIG. 6.

FIG. 7 is a bottom perspective view of a cap for the needle assembly.

### DETAILED DESCRIPTION

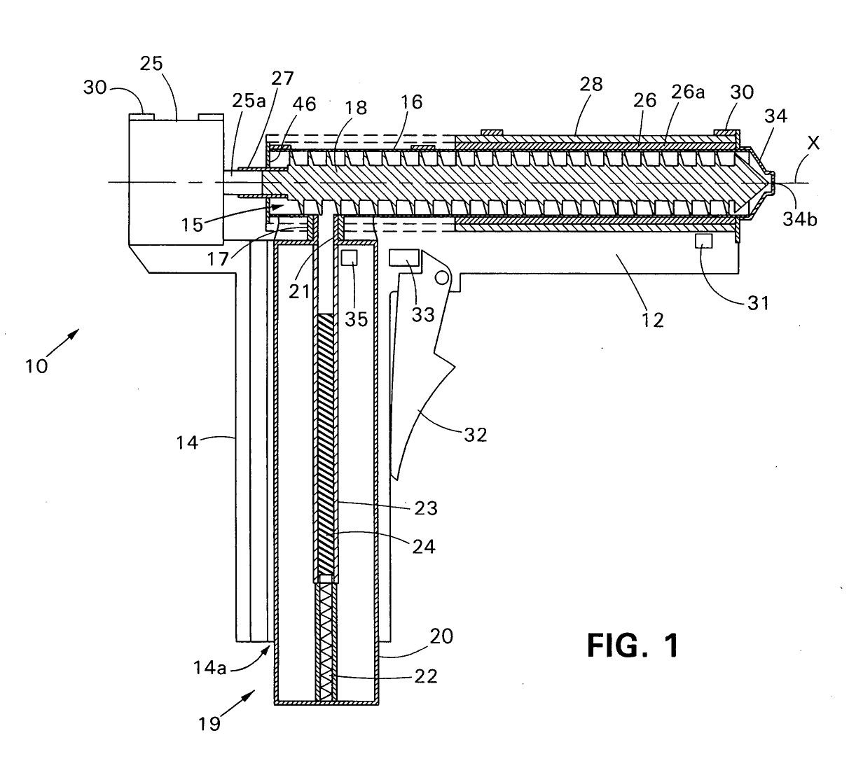

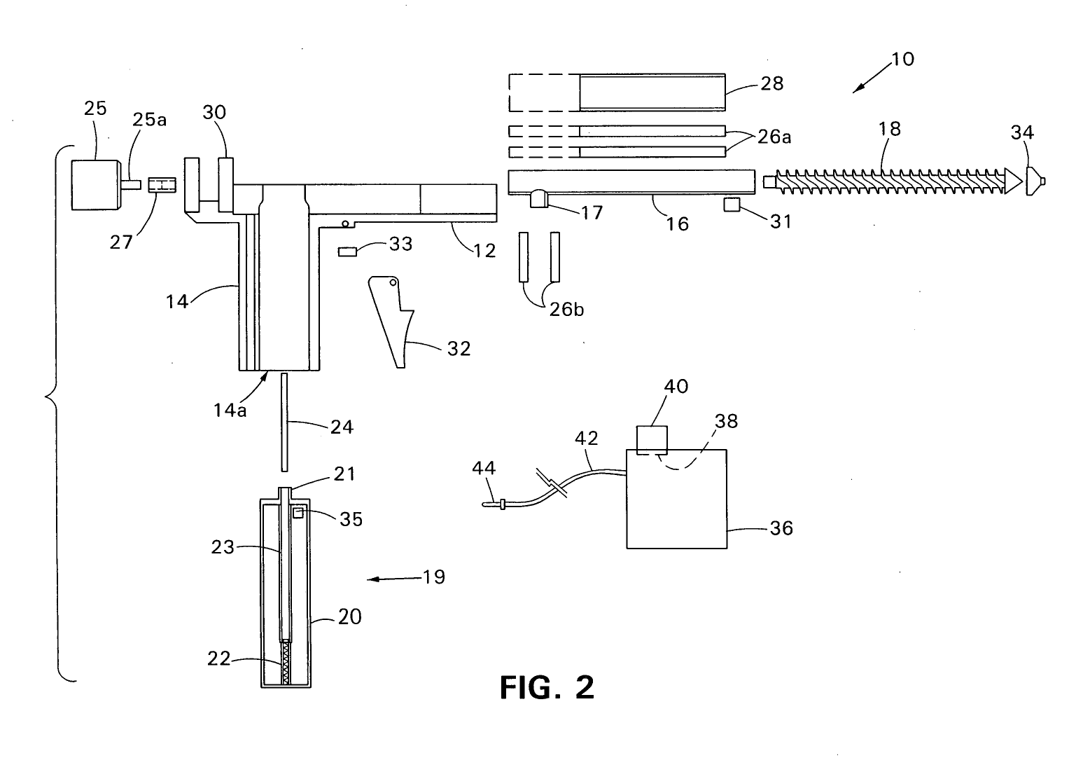

Referring to FIGS. 1 and 2, thermoplastic delivery device 10 can deliver molten polymer or thermoplastic material for desired purposes. Device 10 is described below for use as a dental injection device but it is understood that device 10 can also be used as a hot melt glue gun.

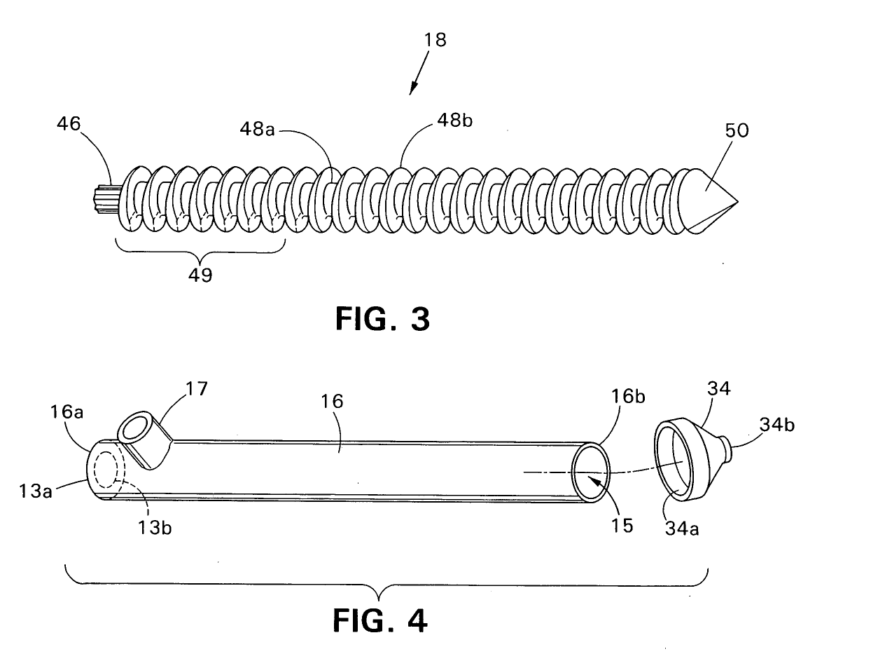

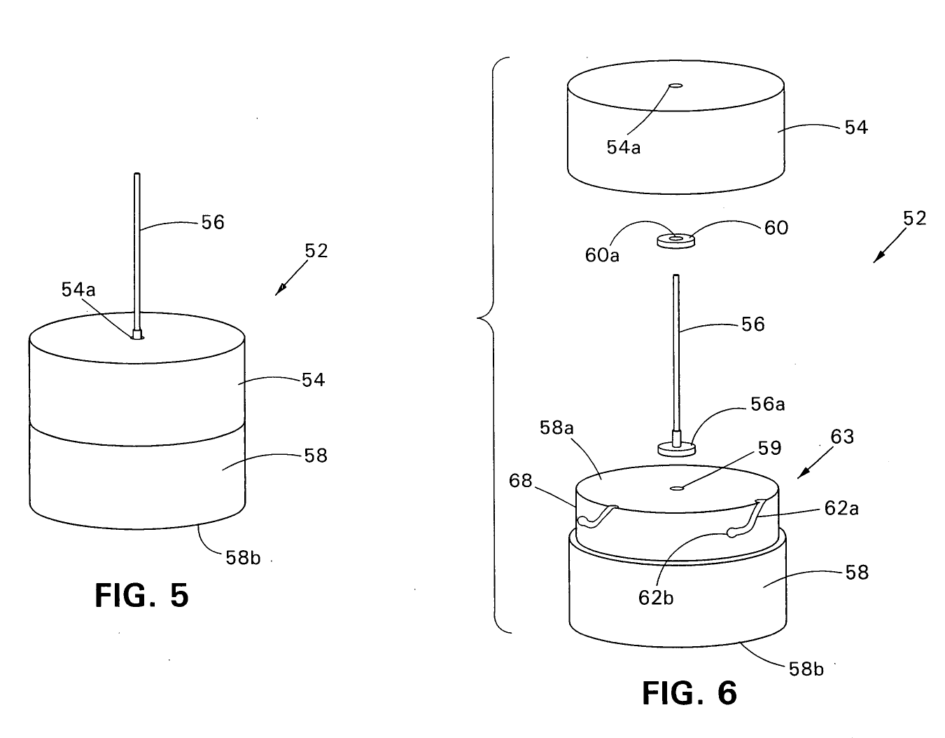

Device 10 can be in the form as a hand held gun as shown in FIG. 1 and include a body 12 and a handle 14 extending generally laterally from the body 12. A feed barrel, tube or conduit 16 (FIG. 4) can be mounted to the body 12. A conveying or advancement screw 18 (FIG. 3) extends within the interior 15 of conduit 16 and can be rotated by a motor drive 25 which is controlled by an actuator 32, such as a trigger. A storage and feed assembly 19 can store and supply thermoplastic 24, such as sticks of gutta percha, into the conduit 16 through conduit inlet 17. Thermoplastic material 24 entering the conduit inlet 17 is conveyed by the conveying screw 18 forwardly by rotation of the screw 18. A heating system 26 having one or more heating elements 26a can heat the conduit 16 and help melt the thermoplastic material 24 within the conduit 16. The molten thermoplastic material 24 within the conduit 16 is forced farther forwardly by the rotating conveying screw 18 to exit the conduit 16 and pass through the opening 34b in a nozzle 34. When employed as a dental injection gun, a needle assembly 52 (FIGS. 5-7) having a needle 56 can be mounted to the nozzle 34 so that the molten thermoplastic material 24 is forced out through the needle 56. The needle 56 can be suitable for insertion into dental cavities for filling the dental cavities with the thermoplastic material 24.

A more detailed description of the embodiment of device 10 depicted in FIGS. 1 and 2 now follows. The feed assembly 19 can be positioned within the handle 14 and can include a magazine storage chamber with a passage 23 (FIG. 2) into which sticks of thermoplastic material 24 can be inserted. The magazine storage chamber can be sized to hold multiple sticks of thermoplastic material 24. The sticks can be longitudinally oriented end to end. A spring loaded mechanism 22 can resiliently bias the sticks of thermoplastic material 24 from the bottom towards the outlet 21 of the feed assembly 19 where the longitudinal axes of the sticks are transverse or at a right angle relative to the conveying screw 18 and screw axis X. The thermoplastic material 24 can be fed into the conduit 16 as the device 10 is being operated for filling dental cavities, or prior to filling the cavities. The feed assembly 19 can be a removable clip 20 which is inserted into the interior 14a of handle 14 so that the outlet 21 can engage the conduit inlet 17. The removable clip 20 can be hollow as shown, or generally solid.

Although the passage 23 is shown to extend only part way through clip 20, alternatively, the passage 23 can extend all the way through to allow loading of the clip 20 from the bottom. In such a case, the spring loaded mechanism 22 can be removable to allow loading from the bottom and then can be reinserted into the passage 23 and locked in place to bias the thermoplastic material 24. In a bottom loading design, the feed assembly 19 does not need to have a removable clip 20 and can be permanently positioned within or be part of the handle 14. In some embodiments, the feed assembly 19 can also be loaded laterally rather than longitudinally. The spring loaded mechanism 22 can include a coil compression spring, or leaf springs. A lever or other mechanism can be used to adjust the tension or to depress or lock the spring loaded mechanism 22 in the down position, for example, during loading. Although longitudinally oriented sticks of thermoplastic material 24 are shown to be introduced at a right angle relative to axis X, alternatively the feed assembly 19 can be configured to introduce sticks that are laterally oriented relative to axis X. In addition to storing and advancing sticks of thermoplastic material 24, the feed assembly 19 can be configured to store and advance thermoplastic material 24 into the conduit 16 that is in other forms, for example, powdered, pelletized, etc. Furthermore, other feed assembly configurations can be employed to store and advance powdered or pelletized thermoplastic material 24, such as a hopper.

The thermoplastic material 24 can enter the conduit 16 through the conduit inlet 17 on a lateral side of conduit 16. In the embodiment shown in FIGS. 2 and 4, the conduit inlet 17 extends or protrudes laterally from the conduit 16, but alternatively, can be a hole in the wall of the conduit 16. The conduit 16 can be made of thermally conductive material and can act as a melt and storage chamber as well as a conveying passage or conduit. The conduit 16 can be generally tubular in shape so that the conveying screw 18 can extend within the interior 15 of the conduit 16 in a close fitting manner along axis X. The proximal end 16a of the conduit 16 can have an end wall 13a with a hole 13b therethrough (FIG. 4) for allowing the shaft 46 of the conveying screw 18 to extend through the end wall 13a for coupling to the motor drive 25. Sealing arrangements can be used in conjunction with hole 13b and inlet 17 to prevent leakage of thermoplastic material 24. The open end 34a of nozzle 34 can be mounted to the distal end 16b or outlet of the conduit 16, for example, by threads or other suitable methods. Although the conduit 16 is shown to be a tubular member in FIGS. 2 and 4, alternatively, conduit 16 can be of other suitable configurations, for example, in one embodiment, can be a bore formed within the body 12.

The conveying screw 18 has an inner diameter 48a and an outer diameter formed by spiral screw threads or flutes 48b which extend radially outward from the inner diameter 48a (FIG. 3). The flutes 48b can be formed by a single continuously angled or spiraling thread, or alternatively, multiple threads. When the conveying screw 18 is rotated, the flutes 48b can continuously and progressively capture or cut into the thermoplastic material 24 received from the lateral inlet 17, and can continuously and progressively push or force the thermoplastic material 24 forwardly through the conduit 16. The portion 49 of the flutes 48b which are positioned near the inlet 17 of the conduit 16 can be sharpened or provided with teeth for aiding in cutting or grinding the thermoplastic material 24 that is fed and drawn into the conduit 16 through the inlet 17. The tip 50 of the conveying screw 18 can be conical for positioning within nozzle 34 as shown. Typically, the conveying screw 18 extends within at least a substantial length of conduit 16, and in the embodiment depicted, can extend about the full length. By forming the flutes 48b to have a close fit with the conduit 16, rotation of the conveying screw 18 can continuously draw in and force thermoplastic material 24 through the conduit 16 with the spiraled flutes 48b longitudinally along axis X towards and through the nozzle 34. The thermoplastic material 24 travels generally concentrically relative to the conveying screw 18 in a forwardly direction occupying the spaces defined by the inner diameter 48a and flutes of the conveying screw 18, and the inner walls of the conduit 16. By having flutes 48b near or adjacent to the nozzle 34, the conveying screw 18 can push or force the thermoplastic material 24 out the nozzle 34 from a location that is near or adjacent to the nozzle 34, which can provide consistent delivery. In contrast, in prior art designs where a plunger pushes sticks of thermoplastic material from the rear, at a position often quite far from the nozzle, the ability to provide consistent and suitable delivery can decrease the farther away the plunger is from the nozzle. As the plunger is farther away from the nozzle, the amount of thermoplastic material that is required to be pushed increases, as well as its resistance to being moved. In some prior art designs, the thermoplastic material at the rear can still be in stick form and the molten thermoplastic material at the forward locations will sometimes move or flow backward around the advancing sticks at the rear, and possibly the plunger, instead of flowing forward.

In the embodiment depicted in FIGS. 1-4, the outer diameter of the flutes 48b and the inner diameter of the conduit 16 have substantially constant diameters so that the mass of thermoplastic material 24 between the flutes 48b is forced longitudinally forwardly along axis X in a generally cylindrical or tubular constant diameter shape. A conveying screw 18 having a generally constant diameter can have an intake rate from inlet 17 that substantially matches the discharge or ejection rate through the distal end 16b of conduit 16 and nozzle 34. In addition, with a constant flute 48b diameter, the pushing force generated by the rotating conveying screw 18 does not decrease near or adjacent to the nozzle 34. Since the flow of the thermoplastic material 24 through the conduit 16 is restricted through the nozzle 34, the pressure of the thermoplastic material 24 can increase in front of the nozzle 34. This increase in pressure can cause an increase in the temperature of the thermoplastic material 24 so that rotation of the conveying screw 18 can aid in the melt process and/or maintain the molten state prior to ejection through the nozzle 34, and when employed, needle 56. Alternatively, in some embodiments, the flutes 48b and conduit 16 can have tapered diameters or tapered portions. The conveying screw 18 can have portions where the flutes 48b can be of varying configuration, such as diameter, spacing, additional structures, etc.

The one or more heating elements 26a of the heating system 26 can be positioned adjacent or against the conduit 16 (FIG. 1) for heating the conduit 16 to help melt and/or maintain the thermoplastic material 24 that is in the conduit 16 in a molten state. Heat is transferred or conducted from the heating elements 26a to the conduit 16 which in turn is transferred or conducted to the thermoplastic material 24 within the conduit 16. The heating elements 26a are shown as flexible sheet heating elements which extend at least part way around and partially along the length of the conduit 16. Alternatively, the heating elements 26a can extend approximately the whole length of the conduit 16 as shown in phantom, and/or completely encircle the conduit 16 depending upon the thermal conductivity of conduit 16 and the operating temperature of the heating elements 26a. The heating elements 26a can also be of other suitable forms, for example, resistance wires or elements wrapped around and/or imbedded in the conduit 16, or rigid longitudinal elements that are suitably positioned. Additional heating elements 26b can be positioned in the region of the inlet 17 and/or feed assembly 19 (FIG. 2) for helping in the melting of the thermoplastic material 24 entering the conduit 16 through inlet 17. Depending upon the configuration of heating elements 26a and 26b, the heating elements can encircle or extend longitudinally adjacent to the desired region to be heated.

A heat shield 28 can cover the heating elements 26a that surround the conduit 16 for shielding and protecting the user from injury. The heat shield 28 can, if needed, substantially surround the conduit 16. The body 12 and handle 14 of device 10 can be made of or include thermally insulative or heat shielding material to aid in the heat shielding. Heat shield 28 can be formed of a ceramic material, fiberglass or include a Mylar® film or metallic heat reflective films such as gold, aluminum, etc. If needed, heat shielding can also be provided in or around the handle 14 of device 10. As shown in phantom in FIGS. 1 and 2, the heat shield 28 can extend over a portion of conduit 16 or substantially the full length. A thin heat shield 28 can allow the device 10 to be made in a compact manner. The conduit 16 and heating elements 26a can be mounted to the body 12 by securement bands 30. Alternatively, the body 12 can have a bore into which the conduit 16 and heating elements 26a are located, and if needed, the heat shield 28 can be inserted into the bore as well. Air gaps can be provided, if desired, in conjunction with the heat shielding.

The motor drive 25 has a drive shaft 25a (FIGS. 1 and 2) which can be secured to the shaft 46 of the conveying screw 18 by a coupling 27. The coupling 27 can be a rigid coupling or can include a clutch mechanism which provides slip when a preset level of torque is reached to prevent damage to the components of device 10. The coupling 27 can be include set screws, keyways, shaped holes, etc., for coupling the drive shaft 25a to the shaft 46. The motor drive 25 can be mounted to the body 12 by securement bands 30, or by other suitable fasteners or methods. The motor drive 25 can be variable speed and can have an AC or DC variable speed motor, and in one embodiment, can have a servo motor. The motor drive 25 can include a gear reducer.

The motor drive 25 can be controlled by an actuator 32, such as a trigger shown in FIGS. 1 and 2. The speed at which motor drive 25 rotates for delivering molten thermoplastic material 24 out through nozzle 34 can be continuously varied depending upon the amount that the actuator 32 is depressed. A potentiometer 33 can be coupled to the actuator 32 for regulating the electrical power that is delivered to the motor drive 25. The more that actuator 32 is depressed, the more power that is delivered for increasing the speed of motor drive 25 and the delivery rate of the thermoplastic material 24. In other embodiments, actuator 32 can be a switch that has a series of settings for delivering different fixed electrical power levels.

The device 10 can include a controller 36 (FIG. 2) for providing power and/or controlling the operation of device 10. Controller 36 can be connected to the handle 14 or the rear portion of body 12 by a cable 42 and connector 44, and can regulate the amount of power provided to the heating system 26 for regulating the temperature, as well as the operation of motor drive 25. For example, the controller 36 can allow operation of motor drive 25 only if the conduit 16 is at a temperature where any thermoplastic material 24 within the conduit 16 would be molten, as sensed by a heat sensor 31, or if there is thermoplastic material 24 present within the feed assembly 19 as sensed by sensor 35. Indicator lights or text on a display screen can notify the user of the operational status. The controlling circuitry of controller 36 can also be included in the handle 14 or body 12 to allow device 10 to be remotely used with a portable power supply 40 which can be electrically connected to device 10 at the handle 14 or rear of body 12 for providing power to device 10. Alternatively, the portable power supply 40 can include controlling circuitry. The controller 36 can have a receptacle 38 for charging the portable power supply 40. The controlling circuitry can also include logic for instructing motor drive 25 to provide reverse turns or partial turns of the conveying screw 18 when the actuator 32 is released at the end of a delivery of thermoplastic material 24 to prevent excess delivery of molten thermoplastic material 24. In addition, the nozzle 34 can be provided with a valve for preventing unwanted delivery of thermoplastic material 24.

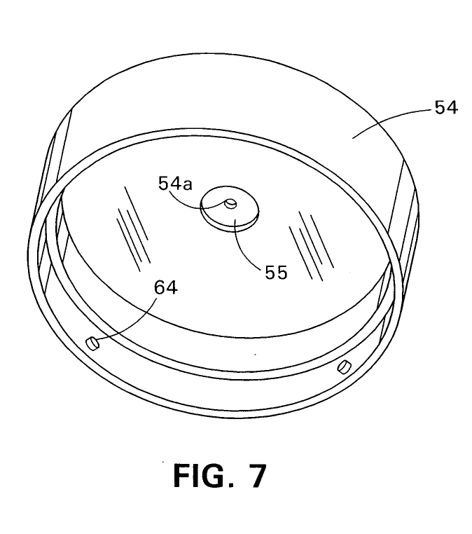

Referring to FIGS. 5-7, when device 10 is employed for filling dental cavities with thermoplastic material 24, needle assembly 52 can be mounted to the nozzle 34 for mounting needle 56 to the distal end 16b of the conduit 16. Needle assembly 52 includes a base 58 in which the proximal end 58b can be secured to nozzle 34, for example, with threads or other suitable methods. Needle 56 can be secured to the base 58 by a cap 54 which can be secured to the base 58 by a bayonet-type locking mechanism 63 (FIG. 6). The needle 56 can be made of thermally conductive material and can be similar to those disclosed in U.S. Pat. Nos. 5,934,903 and 6,168,432, the contents of which are incorporated herein by reference in their entirety. However, other needle configurations are possible. The needle assembly 52 can be also made of thermally conductive materials. The locking mechanism 63 can include a series of angled slots 62a terminating in lateral slot portions 62b on a diameter portion 68 for engaging respective inwardly directed protrusions 64 located on the inner diameter of cap 54. The distal end 58a of base 58 has an opening 59 for aligning with the opening through needle 56. The flange 56a of needle 56 is pressed against the distal end 58a of base 58 by the cap 54. The needle 56 protrudes through a hole 54a in cap 54. A recess 55 surrounds hole 54a for accepting a sealing member 60 which provides an axial sealing force against the flange 56a of needle 56. The sealing number 60 has an opening 60a for allowing the passage of the needle 56. In some embodiments, the needle assembly 52 can be part of the conduit 16 or nozzle 34, where the cap 54 and needle 56 are secured directly to the conduit 16 or nozzle 34. In addition, the needle 56 can be secured by a threaded arrangement.

At least portions of the needle assembly 52, such as the cap 54, can be formed of a heat shielding material, for example, ceramic, for providing heat shielding extending to and around the bottom of the needle 56. Such heat shielding can make the insertion of the needle 56 into a patient's mouth safer. If desired, base 58 can also be formed of heat shielding material. Alternatively, other suitable methods or materials for providing heat shielding extending to and around the needle 56 and/or the mounting arrangements or needle assembly can be employed, such as providing heat shielding in a manner similar to heat shield 28, including flexible or thin heat shielding materials.

When device 10 is used for filling dental cavities, the feed assembly 19 is first checked and, if empty, is filled. The power to device 10 is turned on and the heating system 26 heats the conduit 16. If there is any thermoplastic material 24 in the conduit 16, the thermoplastic material 24 becomes molten. Motor drive 25 can then be allowed to operate and is actuated by actuator 32 to rotate conveying screw 18. Rotation of the conveying screw 18 draws in thermoplastic material 24 from the feed assembly 19 into the conduit 16 through the conduit inlet 17 and forwardly forces molten thermoplastic material 24 within the conduit 16, longitudinally along axis X, through distal end 16b and nozzle 34, and out the needle 56 into the desired dental cavities. The thermal conductivity of the needle 56 can allow the needle 56 to be heated by the heating system 26 and maintain a temperature which allows molten thermoplastic material 24 to pass therethrough without solidifying within the needle 56. By having a feed assembly 19 which holds more than enough thermoplastic material 24 for one patient, dental procedures are less likely to be interrupted for refilling. The thermoplastic material 24 can be injected into the dental cavities at a constant rate by rotating the conveying screw 18 at a constant rotational speed or can vary the delivery by varying the rotational speed of conveying screw 18 with actuator 32. Terminating rotation of the conveying screw 18 stops the delivery of the thermoplastic material 24. If desired, upon stopping, the conveying screw 18 can rotate slightly in reverse for reducing or preventing excess delivery of thermoplastic material 24. When the procedure is over, a purge procedure can be provided in which the conveyor screw 18 can be rotated while the feed assembly 19 is empty, to empty the conduit 16 of any molten thermoplastic material 24.

The precision at which the thermoplastic material 24 can be delivered by device 10 can be determined, among other things, by the selection of the diameter of the conveying screw 18, the pitch of the flutes 48b, the rotational speed of motor drive 25, the sensitivity of the actuator 32 and the logic for controller 36. During operation, the rotating conveying screw 18 enables thermoplastic material 24 to be continuously fed into conduit 16 through inlet 17. In addition, the conveying screw 18 also allows lateral feeding so that feed assembly 19 can be positioned within the handle 14, thereby providing for a compact design.

While this invention has been particularly shown and described with references to particular embodiments thereof, it will be understood by those skilled in the art that various changes in form and details may be made therein without departing from the scope of the invention encompassed by the appended claims.

For example, the device 10 does not need to be in the form of a gun, but instead can be an elongate wand. In addition, in some embodiments, a mechanism can be included for advancing or retracting the conveying screw 18. Furthermore, although feed assembly 19 depicts one column or row of sticks of thermoplastic material 24 stored therein, the feed assembly 19 can be configured to hold more than one column or row of sticks. In such a case, a mechanism can be provided for moving the sticks laterally into the passage 23. Such columns or rows can be fed into the conduit 16 either with the longitudinal axes of the sticks transverse to the axis X or parallel to the axis X. The feed assembly 19 can be positioned at locations and orientations other than in the handle, and can also include other suitable feed mechanisms or devices for advancing the thermoplastic material 24 into the conduit 16, for example, motor driven, pressurized, pneumatic, screw, plunger, or cylinder driven devices. Also, the actuator 32 in some embodiments can provide only a fixed delivery rate of molten thermoplastic material 24, or a series of different fixed delivery rates. Finally, in other embodiments, the conveying screw 18 can be replaced by other ejection arrangements, such as pump type mechanisms, including gear pump, peristaltic, piston, etc., mechanisms.

1. A hand held dental injection device comprising:
a conduit having an inlet and an outlet;
a rotatable conveying screw having conveyance flutes, the screw being positioned within the conduit for conveying thermoplastic material received from the inlet of the conduit alongside the screw through the conduit and out the outlet with the conveyance flutes;
a heating system for heating the thermoplastic material; and
a needle mounted to the outlet of the conduit for directing the thermoplastic material into dental cavities.

2. The injection device of claim 1 further comprising a motor drive for rotating the conveying screw.

3. The injection device of claim 2 further comprising an actuator for actuating the motor drive and varying the speed of the motor drive to vary the speed that the thermoplastic material exits the outlet.

4. The injection device of claim 1 further comprising a feed assembly for feeding the thermoplastic material into the inlet of the conduit.

5. The injection device of claim 4 further comprising a hand held body to which the conduit is mounted.

6. The injection device of claim 5 in which the hand held body includes a handle extending generally laterally from the body, the feed assembly being positioned within the handle.

7. The injection device of claim 6 in which the feed assembly feeds sticks of thermoplastic material into the inlet of the conduit.

8. The injection device of claim 7 in which the feed assembly is spring loaded and the sticks are fed at a right angle to the conveying screw.

9. The injection device of claim 8 in which the feed assembly comprises a removable clip, whereby the clip can be filled with sticks of the thermoplastic material.

10. The injection device of claim 3 further comprising a controller for controlling the motor drive and the heating system.

11. The injection device of claim 10 in which the controller allows rotation of the conveying screw only when the thermoplastic material has been sufficiently heated.

12. The injection device of claim 1 further comprising heat shielding material surrounding at least a portion of the heating system.

13. The injection device of claim 12 in which the heat shielding material extends to the needle.

14. A hand held dental injection device comprising:
a hand held body;
a handle extending generally laterally from the body;
a conduit mounted to the body having an inlet and an outlet;
a feed assembly for feeding thermoplastic material into the inlet of the conduit, the feed assembly being positioned within the handle;
a rotatable conveying screw having conveyance flutes, the screw being positioned within the conduit for conveying the thermoplastic material received from the inlet of the conduit alongside the screw through the conduit and out the outlet with the conveyance flutes;
a heating system for heating the thermoplastic material;
heat shielding material surrounding at least a portion of the heating system; and
a needle mounted to the outlet of the conduit for directing the thermoplastic material into dental cavities.

15. A method of filling dental cavities with a hand held dental injection device comprising:
rotating a conveying screw having conveyance flutes within a conduit, the conduit having an inlet and an outlet, the conveying screw for conveying thermoplastic material received from the inlet of the conduit alongside the screw through the conduit and out the outlet with the conveyance flutes;
heating the thermoplastic material with a heating system; and
directing the thermoplastic material into the dental cavities with a needle mounted to the outlet of the conduit.

16. The method of claim 15 further comprising rotating the conveying screw with a motor drive.

17. The method of claim 16 further comprising actuating the motor drive and varying the speed of the motor drive to vary the speed that the thermoplastic material exits the outlet with an actuator.

18. The method of claim 15 further comprising feeding the thermoplastic material into the inlet of the conduit with a feed assembly.

19. The method of claim 18 further comprising mounting the conduit to a hand held body.

20. The method of claim 19 in which the body includes a handle extending generally laterally from the body, the method further comprising positioning the feed assembly within the handle.

21. The method of claim 20 further comprising feeding sticks of thermoplastic material into the inlet of the conduit.

22. The method of claim 21 further comprising spring loading the feed assembly and feeding the sticks at a right angle to the conveying screw.

23. The method of claim 22 in which the feed assembly comprises a removable clip, the method further comprising filling the clip with sticks of the thermoplastic material.

24. The method of claim 17 further comprising controlling the motor drive and the heating system with a controller.

25. The method of claim 24 further comprising rotating the conveying screw only when the thermoplastic material has been sufficiently heated.

26. The method of claim 15 further comprising surrounding at least a portion of the heating system with heat shielding.

27. The method of claim 26 further comprising extending the heat shielding to the needle.
